(19) United States
(12) Patent Application Publication
(10) Pub. No.: US 2013/0060834 A1
(43) Pub. Date: Mar. 7, 2013

(54) DISTRIBUTED MESSAGING SYSTEM CONNECTIVITY AND RESOURCE MANAGEMENT

(71) Applicants: Kartik Paramasivam, Redmond, WA (US); Sung Hwa Jin, Bellevue, WA (US); Ruppert Koch, Redmond, WA (US)

(72) Inventors: Kartik Paramasivam, Redmond, WA (US); Sung Hwa Jin, Bellevue, WA (US); Ruppert Koch, Redmond, WA (US)

(73) Assignee: Microsoft Corportion, Redmond, WA (US)

(21) Appl. No.: 13/420,620

(22) Filed: Mar. 15, 2012

Related U.S. Application Data
(60) Provisional application No. 61/532,037, filed on Sep. 7, 2011.

(51) Int. Cl. G06F 15/16

(52) U.S. Cl. 709/202

(57) ABSTRACT

A distributed messaging system includes a gateway having an interface to receive client messages and having access to a gateway database and to a messaging host that supports multiple partitions that are executed on processors of a cluster of processors. Each of the partitions supports execution of at least one message broker. The gateway database includes a mapping between each of the message brokers and one of the multiple partitions. An admin agent may periodically scan the gateway database to check if the message brokers reach a capacity threshold. The admin agent may create new message brokers and add the new message brokers to a pool of message brokers to allow new queues to be associated with the new message brokers.

### BACKGROUND

A messaging system that uses a service bus architecture may support message queuing and message publication/subscription and may utilize decoupled communication. Using such a messaging system, clients and servers can perform operations in an asynchronous fashion.

The messaging system may use message brokers that route messages from producers to queues and from queues to consumers. The use of message brokers may cause certain system scalability issues since each message broker may be limited to a single computer with finite resources. Thus, as the number of clients and the volume of message traffic changes (e.g., increases or decreases), scalability and maintaining performance of the messaging system becomes a challenge.

### SUMMARY

The present disclosure relates to a distributed messaging system. The distributed messaging system includes a gateway having an interface to receive client messages and having access to a gateway database. The distributed messaging system includes at least one messaging host that supports multiple partitions that are executed on processors of a cluster of processors. Each of the partitions supports execution of at least one message broker. The gateway database includes a mapping between each message broker and one of the multiple partitions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a particular embodiment of a distributed messaging system;

FIG. 2 is a block diagram that illustrates further details of the distributed messaging system of FIG. 1;

FIG. 3 is a flow diagram of a particular embodiment of a method of operation of the distributed messaging system of FIGS. 1 and 2; and

FIG. 4 is a diagram of a computer system that may be used in connection with the distributed messaging system of FIGS. 1 and 2.

### DETAILED DESCRIPTION

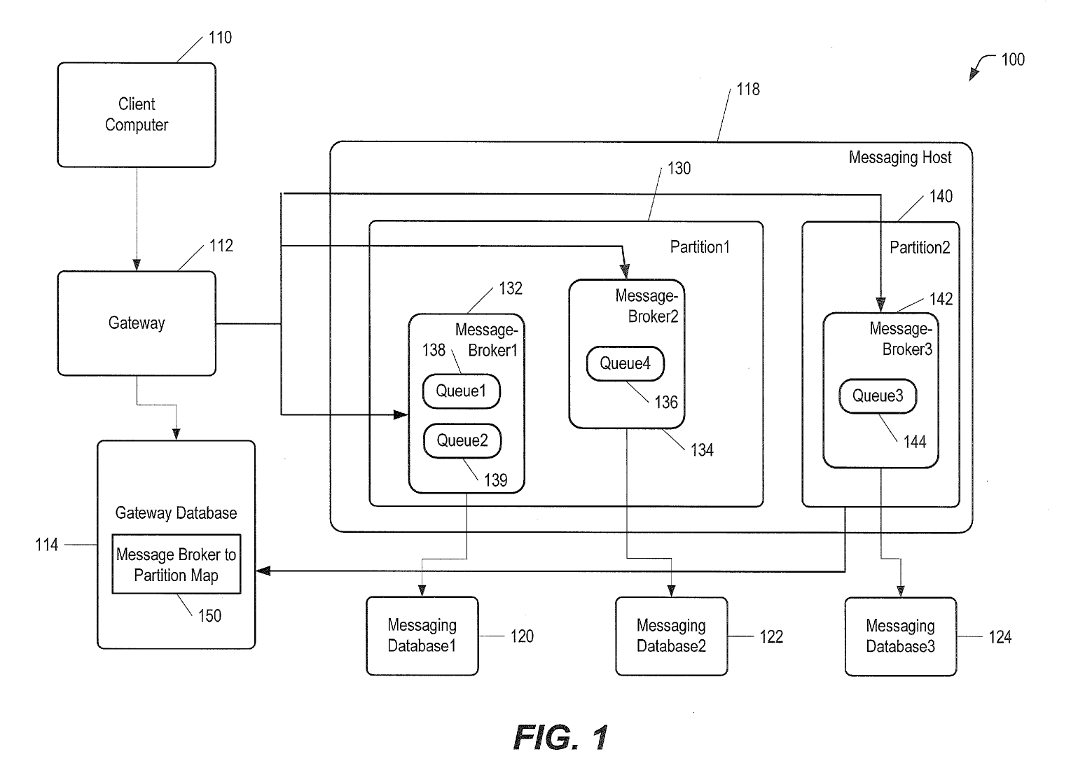

Referring to FIG. 1, a particular illustrative embodiment of a distributed messaging system 100 is shown. The distributed messaging system 100 includes a messaging host 118, a gateway 112, a gateway database 114, and a plurality of messaging databases 120, 122, and 124. The messaging host 118 includes a plurality of partitions including a representative first partition 130 and a representative second partition 140. While two partitions 130, 140 have been shown, it should be understood that the messaging host 118 may include one partition or more than two partitions. The representative first partition 130 includes or supports execution of a representative first message broker 132 and a representative second message broker 134. While the first partition 130 includes two message brokers 132, 134, it should be understood that each of the partitions 130, 140 may include one or more message brokers or no message brokers. A message broker is a software service that provides support for a variety of messaging patterns. These patterns may include (but are not limited to) a queue and a topic. A messaging entity may refer to a queue or a topic. The first message broker 132 includes a first queue 138 and a second queue 139. The second message broker 134 includes a fourth queue 136. The second partition 140 includes or supports execution of a third message broker 142 that includes a third queue 144. In other embodiments, each of the queues 138, 139, 144, 136 may be replaced by another messaging entity, such as a topic, or each of the message brokers may include multiple queues and topics.

The distributed messaging system 100 allows several publishers to enqueue/publish messages in a queue. These messages are stored (e.g., in the messaging databases 120-124). Several consumers can dequeue such stored messages.

The gateway 112 is responsive to input from a representative client computer 110. The gateway 112 may be implemented as software that each client interfaces with to access the messaging entities (queues or topics) of the messaging service. A client may be any party (e.g., a computing device of a party) that is sending messages to or receiving messages from a messaging service or a message broker. A client that sends messages to the messaging service/broker may be referred to as a message publisher. A client that receives messages from the messaging service/broker may be referred to as a message consumer. The input from the representative client computer 110 may be a request for data to be sent to or retrieved from a particular one of the queues (or topics) within one or more message brokers. Messages may be organized by topic so that multiple subscribers can register an interest (e.g., as a subscription) in receiving messages that were published to a particular topic. Subscribers can optionally register rules/filters to determine if they are interested in the message. Messages that are published to a topic are delivered to matching subscriptions.

The gateway 112 is coupled to or otherwise has access to a gateway database 114 that includes a message broker to partition map 150. The message broker to partition map 150 may be implemented as a table that maps each of the message brokers within the distributed messaging system 100 to an identified partition within one or more messaging hosts (e.g., the messaging host 118) within the distributed messaging system 100. The gateway database 114 may also include a list of queues (or topics) and their sizes and information regarding mapping of individual queues (or topics) to their corresponding message brokers. The message brokers are mapped to their corresponding partitions by the message broker to partition map 150.

While only a single messaging host 118 is shown in FIG. 1, it should be understood that the distributed messaging system 100 may include multiple messaging hosts, and each messaging host may be similar to the messaging host 118 illustrated in FIG. 1 and each of the messaging hosts would be coupled to the gateway 112.

In a particular embodiment, each message broker may include a messaging entity (e.g., a queue or a topic). The messaging host 118 is coupled to a plurality of messaging databases 120-124, and each of the message brokers 132, 134, 142 has an assigned database of the messaging databases 120-124.

For example, each of the message brokers may have or be assigned corresponding storage (e.g., its own messaging database) where it stores messages in a queue/topic. To illustrate, the first message broker 132 has a corresponding first messaging database 120, the second message broker 134 has a corresponding second messaging database 122, and the third message broker 142 has a corresponding third message database 124.

In a particular embodiment, the distributed messaging system 100 may include logic (as part of an application fabric) to manage virtual machines. For example, the message brokers, the partitions, the messaging databases, or a combination thereof, may be implemented by use of virtual machines that operate on one or more processors of a processor cluster. The logic may manage the virtual machines and/or the processor cluster to allocate resources. To illustrate, the logic may be able to add at least one processor to the cluster of processors. In another illustrative example, the logic may support adding a partition, a message broker, or a messaging database (by adding one or more virtual machines or hardware resources). The distributed messaging system 100 may also include logic within the messaging host 118 to load balance the partitions over each of the virtual machines (including any added virtual machines).

During operation of the distributed messaging system 100, when a user/customer creates a new queue/topic, then the new queue/topic may be mapped to an appropriate message broker using one of the following algorithms:

A) Map the newly created queue (or topic) to a message broker whose messaging database has the most available space. Using this algorithm, every messaging database 120, 122, 124 may be equally loaded.
B) Map the newly created queue to a message broker whose message database has the least free space, but enough free space to fit the newly created queue/topic. Using this algorithm, databases are packed, such that if after some time a set of databases are no longer being used, then these databases would automatically be deleted.

When a new message broker is created, the new message broker may be mapped to a partition that does not have any message brokers associated therewith or to a partition with existing message brokers.

The gateway database 114 includes a list of queues or topics, the sizes of each of the queues or topics, and a mapping of individual queues or topics to corresponding message brokers. Each of the message brokers is mapped to a partition of the distributed messaging system 100. For example, the message brokers 132, 134 are mapped to the first partition 130 and the message broker 142 is mapped to the second partition 140.

The distributed messaging system 100 may provide a cloud-based messaging service. The messaging service aggregates a collection of message brokers and presents an interface to users as a single distributed messaging system. With the messaging service, both processor and storage resources are harnessed to allow scaling of the number of queues/topics seamlessly. The distributed messaging system 100 uses an application fabric which has the ability to create a distributed application across a set of machines. The application fabric has the ability to execute software (e.g., the messaging host 118) in a cluster of machines (e.g., one or more processors of a processor cluster or one or more virtual machines executed at the one or more processors) based on a specified configuration. The application is divided up into a set of partitions (which may be preconfigured), and the application fabric assigns each partition for execution on one of the machines in the cluster. Message brokers are dynamically mapped to various processing nodes with the goal of leveraging new compute power (e.g., new CPUs) that is added to the distributed messaging system 100 based on customer load.

For example, the messaging brokers 132, 134, 142 are mapped to individual partitions in the application fabric by the message broker to partition map 150. When a messaging host starts (e.g., the messaging host 118), the application fabric is used to assign a set of partitions to the messaging host.

The messaging host 118 accesses a central database (e.g., the gateway database 114) to identify which message brokers have been mapped to each partition that the message host 118 owns. The messaging host 118 derives storage connection information and other information from the central database and then starts the message brokers.

In a particular embodiment, a number of message containers (e.g., message brokers, queues or messaging databases) that are mapped to partitions can be increased over time. For example, when a messaging service (such as the distributed messaging system 100) is initially deployed, the messaging service may be implemented using a relatively small number of partitions (e.g., 32 partitions) and a relatively small number of virtual machines (e.g., 8 virtual machines). Any number of message containers (N) may be created in the initially deployed partitions. When the initially deployed partitions in the virtual machines or the number of virtual machines are not sufficient to handle the load for the N message containers (e.g., due to processing or storage constraints), the distributed messaging system 100 can add virtual machines to grow up to a maximum size of the cluster (e.g., up to a maximum number of virtual machines or a maximum number of partitions). As new virtual machines are added, the partitions may be load balanced by the application fabric across the new virtual machines.

Once the number of virtual machines reaches the maximum size of the cluster (e.g., the maximum number of virtual machines and/or partitions), it is possible to re-size the application fabric (e.g., by adding one or more processor resources to the cluster of processors implementing the application fabric) to, increase the maximum number of partitions since the message brokers are loosely associated to the partitions. For example, the number of partitions may change from 32 to 100 without changing the association of message brokers to partitions. Thus, by having message brokers that can be mapped to partitions, the size of a cluster may be easily grown, providing processor scalability for the distributed messaging system 100.

In a particular embodiment, the number of virtual machines may initially be less than the number of partitions. For example, the number of virtual machines may initially be 16 with 64 partitions from the cluster. The system can then grow the cluster up to 64 virtual machines without adding partitions. At that point each virtual machine has one partition and each partition would have many message brokers.

The gateway database 114 includes a list of queues or topics and sizes of each of the queues and topics and a mapping of individual queues or topics to corresponding message brokers. Each of the message brokers is mapped to a partition of the distributed messaging system by the message broker to partition map 150. In a particular embodiment, the message brokers may be mapped to partitions using a distribution algorithm (e.g., a round robin). Message containers (e.g., message brokers, queues/topics and/or messaging databases) can be created and mapped to partitions based on the load of each partition. For example, the message brokers 132, 134 are mapped to the first partition 130 and the message broker 142 is mapped to the second partition 140.

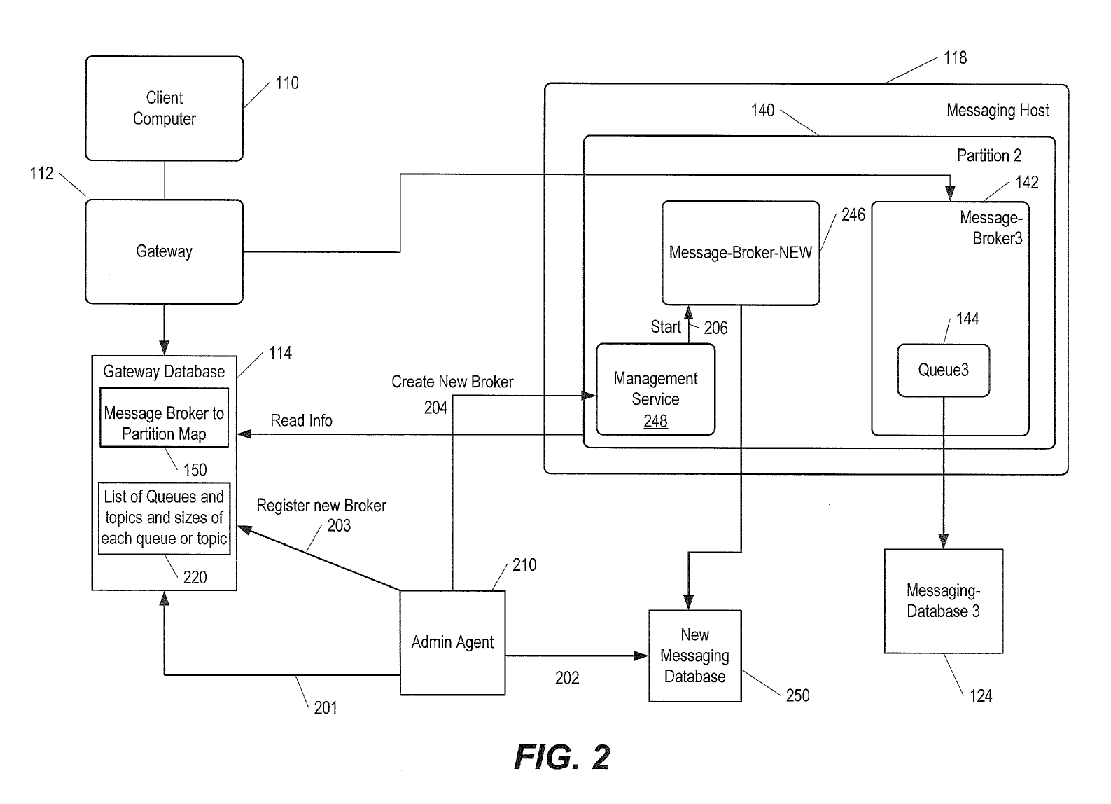

Referring to FIG. 2, further details regarding a portion of the messaging system 100 are shown. The portion of the messaging system 100 illustrated in FIG. 2 includes many of the elements presented in FIG. 1. For example, the client computer 110, the gateway 112, the gateway database 114, the messaging database 124 and, the messaging host 118 that includes the second partition 140 and the third message broker 142 as illustrated and described with reference to FIG. 1 are also shown in FIG. 2.

The portion of the messaging system 100 shown in FIG. 2 further includes additional components, such as an administrative agent 210, a new messaging database 250, a new message broker 246, and a management service 248. The administrative agent 210 is coupled to monitor the gateway database 114 and to communicate with the messaging host 118 via the management service 248. The administrative agent 210 is configured to monitor the gateway database 114 and to monitor the storage capacity of multiple message databases 120-124 corresponding to the message brokers 132, 134, 142. In addition, the administrative agent 210 may create the new database 250 for use by the new message broker 246 within a partition (e.g., the second partition 140) of the messaging host 118. The administrative agent 210 may be implemented as software that monitors the health of the messaging system 100. While not shown specifically in FIG. 2, the administrative agent 210 may communicate with additional messaging hosts within the distributed messaging system. The new message broker 246 is created within one of the partitions, and the management service 248 starts the new message broker 246 in response to a command from the administrative agent 210.

During operation, the administrative agent 210 may monitor the gateway database 114 that includes a list 220 of queues or topics and sizes of each of the queues or topics. The gateway database 114 also includes the message broker to partition map 150 that maps message brokers to partitions and may also map individual queues or topics to corresponding message brokers.

The administrative agent 210 may compute a storage capacity of the distributed messaging system 100 based on a number of storage databases of the distributed messaging system 100 and based on the capacity of each of the storage databases. In a particular embodiment, the administrative agent 210 computes a maximum storage capacity of the distributed messaging system 100 as the number of databases multiplied by the maximum size of every database (i.e. a fixed size).

The administrative agent 210 may compute an allocated storage capacity as a cumulative size of all created queues/topics and then check whether a particular percentage threshold (e.g., 15%) of the maximum storage capacity is free/available (e.g. not allocated). When free/available storage capacity is less than the particular percentage threshold (e.g., 15% of the maximum storage capacity), the administrative agent 210 creates a set of message broker databases.

The administrative agent 210 may determine a portion of the storage capacity that is allocated and a portion of the storage capacity that is unallocated. The portion of the storage capacity that is unallocated may be compared to a threshold, and based on the comparison of the unallocated storage capacity to the threshold, the administrative agent 210 may determine whether or not to create a new message broker. For example, if the unallocated storage capacity is less than the threshold, the administrative agent 210 may determine to create the new message broker 246.

Upon determining to create the new message broker 246, the administrative agent 210 notifies the messaging host 118 of the new message broker 246 and the corresponding partition for the new message broker 246. For example, the administrative agent 210 may call the messaging host 118 at the second partition 140 indicating that the new message broker 246 has been created for the second partition 140. The administrative agent 210 receives information regarding the particular partition for the new message broker 246 by accessing the gateway database 114. For example, the messaging host 118 may access the gateway database 114 to look up a connection string (e.g., access information) corresponding to the newly created message broker 246. The administrative agent 210 may send a message 201 to notify the gateway database 114 of a request for a new broker. The administrative agent 210 may create a new database 250 by sending a creation message 202 and may register the new message broker, at 203, with the gateway database 114. Thereafter, the administrative agent 210 may create the new message broker 246 by sending a create new broker message 204, or a register new broker message, to the management service 248.

Upon receipt of the create new broker message 204 (or a register new broker message), the management service 248 sends a start message or command 206 to create and start the new message broker 246 within the second partition 140. The new message broker 246 is assigned to and has access to the new messaging database 250. Thereafter, queues or topics may be stored within the new message broker 246, and the new message broker 246 is active and may respond to requests from the client computer 110 via the gateway 112 in a manner similar to other message brokers within the second partition 140.

By allowing the addition of new message brokers and new messaging databases in view of changes in processor loading and storage availability, the messaging host 118 of the distributed messaging system 100 supports scalability of a messaging service.

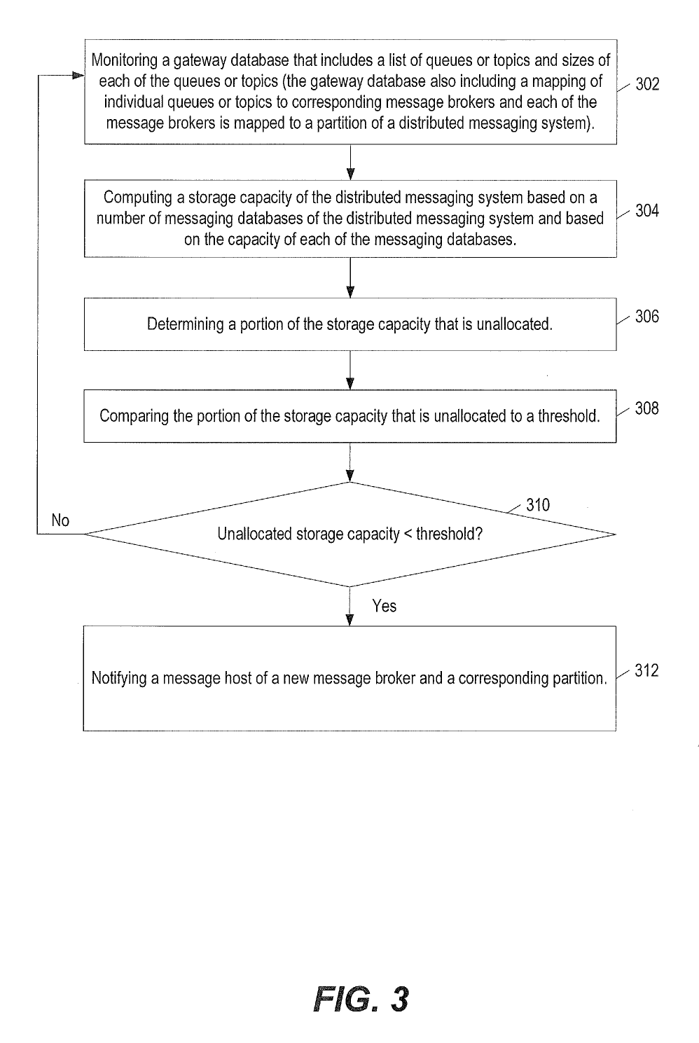

Referring to FIG. 3, a particular illustrative embodiment of a method that may be performed within a distributed messaging system (e.g., the distributed messaging system 100 of FIGS. 1 and 2) is shown. The method includes monitoring a gateway database, at 302, where the gateway database includes a list of queues or topics and sizes of each of the queues or topics. The gateway database includes a mapping of individual queues or topics to corresponding message brokers. For example, the administrative agent 210 monitors the gateway database 114. Upon detection of a new queue or topic, the new queue or topic is mapped to a selected message broker of the plurality of message brokers. The selected message broker may be the message broker that has a corresponding message broker database with the most available space. Alternatively, the selected message broker may be the message broker that has a corresponding message broker database with the least available space but enough available space for the new queue or topic. Each of the message brokers is mapped to a partition of the distributed management system. For example, the gateway database 114 includes a message broker to partition map 150 that maps each message broker to a partition. In a particular illustrative embodiment, a new message broker is mapped to a partition using round robin distribution.

The method further includes computing a storage capacity of the distributed messaging system based on a number of storage databases (e.g., messaging databases 120, 122, 124 and/or 250 of FIGS. 1 and 2) of the distributed messaging system and based on capacity of each of the storage databases, at 304. For example, data within the gateway database 114 may indicate the number of storage databases and the capacity of each of the storage databases. The gateway database 114 includes the list of queues or topics and the size of each of the queues or topics. In a particular embodiment, the method further includes detecting that one or more of the messaging databases are unused and deleting the one or more of the unused messaging databases. In another example, an allocated storage capacity and an unallocated storage capacity of the distributed messaging system may be determined, at 306, by evaluating a cumulative size of all queues and topics for the distributed messaging system. The storage capacity of the distributed messaging system may equal the sum of the allocated storage capacity and the unallocated storage capacity.

The method further includes comparing the portion of the storage capacity that is unallocated to a threshold, at 308. If the unallocated storage capacity is less than the threshold, at 310, then the method includes creating a new message broker in a partition, and notifying a messaging host of the new message broker and the corresponding partition, at 312. In response to receiving the notification of the new message broker, the messaging host retrieves information (e.g., a connection string) from the gateway database that corresponds to the new message broker and starts execution of the new message broker. However, if the unallocated storage capacity is not less than the threshold, at 310, then the method continues monitoring the gateway database, at 302.

Thus, the method of FIG. 3 enables dynamically creating new message brokers responsive to changes in storage capacity or other resources of a distributed messaging system by a distributed messaging service.

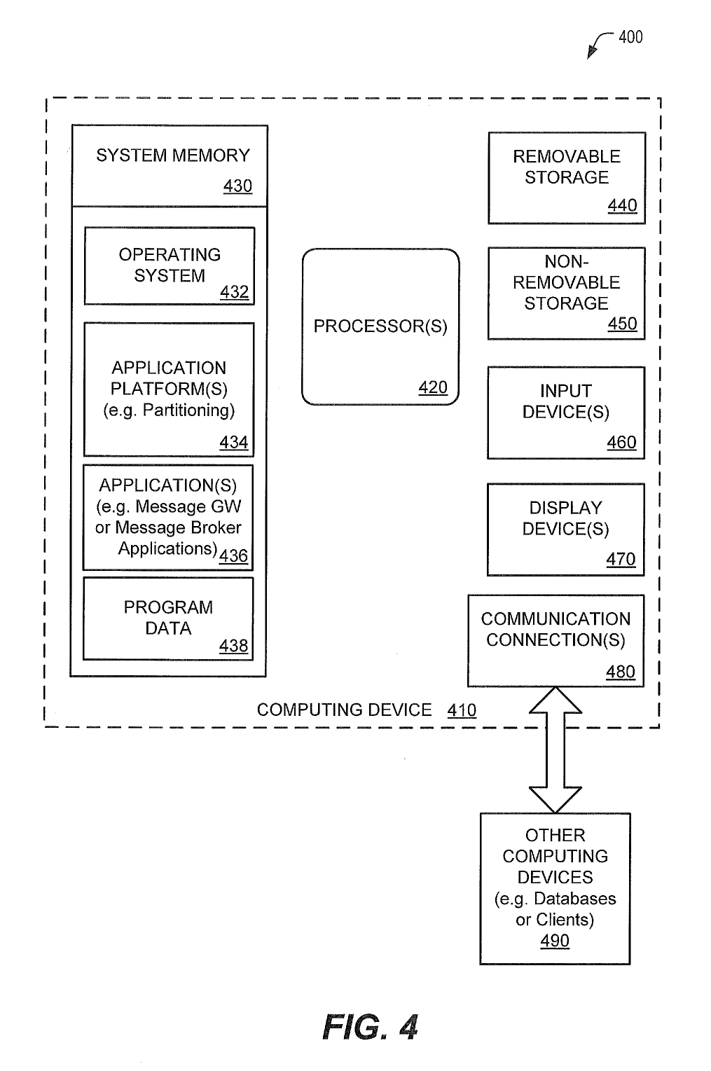

FIG. 4 is a block diagram illustrating a particular embodiment of a computing environment 400 including a computing device to support systems, methods, and computer program products described in FIGS. 1-3.

FIG. 4 depicts a block diagram of a computing environment 400 including a computing device 410 operable to support embodiments of computer-implemented methods, computer program products, and system components according to the present disclosure. In an illustrative embodiment, the computing device 410 may include or be used to implement one or more of the client computer 110, the gateway 112, the gateway database 114, the messaging host 118 (and any components therein), any of the messaging databases 120, 122, 124 of FIG. 1, the administrative agent 210, the messaging service 248, the messaging database 250, or the message broker 246 of FIG. 2.

The computing device 410 includes at least one processor 420 and a system memory 430. Depending on the configuration and type of the computing device 410, the system memory 430 may be volatile (such as random access memory or “RAM”), non-volatile (such as flash memory and similar memory devices that maintain stored data even when power is not provided), or some combination of the two. The system memory 430 typically includes an operating system 432, one or more application platforms 434, one or more applications 436, and may include program data 438 associated with the one or more applications 436. In an illustrative embodiment, the computing device 410 includes application platforms 434 and distributed messaging system applications 436. The application platforms 434 may include partitioning logic, such as a partitioning system of a clustered computing environment configured to support message brokers as described with respect to the distributed messaging system 100. The distributed messaging system applications 436 may include applications for implementing the gateway 112, the gateway database 114, or any of the message brokers 132, 134, 142, or 246. In addition, the distributed messaging system applications 436 may support one or more of the messaging databases 120, 122, 124, and 250.

The computing device 410 may also have additional features or functionality. For example, the computing device 410 may also include removable and/or non-removable additional data storage devices, such as magnetic disks, optical disks, tape, and standard-sized or miniature flash memory cards. Such additional storage is illustrated in FIG. 4 by removable storage 440 and non-removable storage 450. Computer storage media may include volatile and/or non-volatile storage and removable and/or non-removable media implemented in any method or technology for storage of information, such as computer-readable instructions, data structures, program components or other data. The system memory 430, the removable storage 440 and the non-removable storage 450 are all examples of computer storage media. The computer storage media may include, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other tangible medium that can be used to store information and that can be accessed by the computing device 410. Any such computer storage media may be part of the computing device 410.

The computing device 410 may also have input device(s) 460, such as a keyboard, mouse, pen, voice input device, touch input device, etc. Output device(s) 470, such as a display, speakers, printer, etc. may also be included. The computing device 410 also contains one or more communication connections 480 that allow the computing device 410 to communicate with other computing devices 490 over a wired or a wireless network. The other computing devices 490 may include databases or clients. For example, the other computing devices 490 may include the client computer 110 or any of the databases described with respect to the distributed messaging system 100 as shown in FIG. 1 and FIG. 2.

It will be appreciated that not all of the components or devices illustrated in FIG. 4 or otherwise described in the previous paragraphs are necessary to support embodiments as herein described. For example, the input device(s) 460 and output device(s) 470 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process or instruction steps described in connection with the embodiments disclosed herein may be implemented as electronic hardware, computer software, or combinations of both. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware, in a software module executed by a processor, or in a combination of the two. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A distributed messaging system comprising:
a gateway having an interface to receive a client message and having access to a gateway database; and
a messaging host that supports multiple partitions and that isexecutable on at least one processor,
wherein each of the partitions supports execution of at least one message broker, and wherein the gateway database includes a mapping between each message broker and one of the multiple partitions.

2. The system of claim 1, wherein each message broker includes a messaging entity of a queue or a topic.

3. The system of claim 1, wherein the messaging host is coupled to a plurality of messaging databases and wherein each of the message brokers has an assigned database of the plurality of messaging databases.

4. The system of claim 1, further comprising logic to add a previously unused partition to the multiple partitions.

5. The system of claim 1, further comprising logic to create a new message broker, wherein the new message broker is mapped to a partition that does not have any message brokers associated therewith or that has the least number of message brokers.

6. The system of claim 1, further comprising an administrative agent that has access to the gateway database.

7. The system of claim 6, further comprising a management service that starts a new message broker in response to a command from the administrative agent, wherein the new message broker is created within one of the multiple partitions.

8. The system of claim 6, wherein the administrative agent monitors the gateway database and monitors storage capacity of multiple message broker databases corresponding to multiple message brokers.

9. The system of claim 1, wherein the gateway database includes a list of queues or topics, sizes of each of the queues or topics, and a mapping of individual queues or topics to corresponding message brokers, and wherein each of the message brokers is mapped to one of the multiple partitions.

10. A method of adding storage capacity to a distributed messaging system, the method comprising:
monitoring a gateway database that includes a list of queues or topics and sizes of each of the queues or topics, the gateway database also including a mapping of individual queues or topics to corresponding message brokers, wherein each of the message brokers is mapped to a partition of a distributed messaging system;
computing a storage capacity of the distributed messaging system based on a number of messaging databases of the distributed messaging system and based on a capacity of each of the messaging databases;
determining a portion of the storage capacity that is unallocated;
comparing the portion of the storage capacity that is unallocated to a threshold;
in response to the portion of the storage capacity that is unallocated satisfying the threshold, creating a new messaging database, registering a new message broker assigned to the new messaging database at the gateway database, and mapping the new message broker to a particular partition of the distributed messaging system by updating mapping information within the gateway database; and
notifying a messaging host of the new message broker and of the particular partition.

11. The method of claim 10, wherein in response to receiving the notification of the new message broker, the messaging host retrieves a connection string that corresponds to the new message broker from the gateway database and starts execution of the new message broker.

12. The method of claim 10, wherein the new message broker is mapped to the particular partition of a plurality of partitions of the distributed messaging system using round robin distribution.

13. The method of claim 10, further comprising detecting a new queue or topic, and mapping the new queue or topic to a selected message broker of the distributed messaging system, wherein the selected message broker is a particular messaging broker that has a corresponding messaging database with most available space.

14. The method of claim 10, further comprising detecting a new queue or topic, and mapping the new queue or topic to a selected message broker of the distributed messaging system, wherein the selected message broker is a particular message broker that has a corresponding messaging database with least available space but enough available space for the new queue or topic.

15. The method of claim 14, further comprising detecting that a particular messaging database is unused and deleting the particular messaging database.

16. The method of claim 10, further comprising determining a portion of the storage capacity that is allocated, wherein the portion of the storage capacity that is allocated is a cumulative size of all queues and topics for the distributed messaging system.

17. The method of claim 16, wherein the storage capacity of the distributed message system is the portion of the storage capacity that is allocated and a portion of the storage capacity that is unallocated.

18. A computer readable storage device including instructions that are executable by a processor to:
monitor a gateway database that includes a list of queues or topics and sizes of each of the queues or topics, the gateway database also including a mapping of individual queues or topics to corresponding message brokers, wherein each of the message brokers is mapped to a partition of a distributed messaging system;
compute a storage capacity of the distributed messaging system based on a number of messaging databases of the distributed messaging system and based on a capacity of each of the messaging databases;
determine a portion of the storage capacity that is unallocated;
compare the portion of the storage capacity that is unallocated to a threshold;
in response to the portion of the storage capacity that is unallocated satisfying the threshold, create a new messaging database, registering a new message broker assigned to the messaging database at the gateway database, and mapping the new message broker to a particular partition of the distributed messaging system by updating mapping information within the gateway database; and
notify a messaging host of the new message broker and of the particular partition.

19. The computer readable storage device of claim 18, wherein the new message broker is mapped to the particular partition of a plurality of partitions of the distributed messaging system using a round robin distribution.

20. The computer readable storage device of claim 18, wherein in response to receiving the notification of the new message broker, the messaging host retrieves a connection string that corresponds to the new message broker from the gateway database and starts execution of the new message broker.
